(19) United States
(12) Patent Application Publication
(10) Pub. No.: US 2025/0354628 A1
(43) Pub. Date: Nov. 20, 2025

(54) MANUAL TUBE LASHING APPARATUS

(71) Applicant: Brandon Taylor Sickler, Sayre, PA (US)

(72) Inventor: Brandon Taylor Sickler, Sayre, PA (US)

(21) Appl. No.: 18/663,466

(22) Filed: May 14, 2024

(51) Int. Cl. F16L 3/14; A01G 23/10

(52) U.S. Cl. CPC F16L 3/14; A01G 23/10

(57) ABSTRACT

An apparatus for lashing tubing lends resiliency and rigidity to plastic tubing. The apparatus includes a body and two wiring assemblies. The body is formed of a first portion and a second portion connected by a plurality of hinges and securable by a plurality of latches. The first and second portion each include a plurality of bearings disposed on their interior aspect. The first and second portion each include a handle portion disposed proximate to a first end and a wire guide assembly disposed proximate to a second end. The wiring assemblies each include a wire spool, installed on a bolt, and disposed between a tensioning mechanism.

### BACKGROUND OF THE INVENTION

The present invention relates to tube lashing apparatuses, and, more particularly, to a manual tube lashing apparatus for maple tubing.

The introduction of plastic tubing for maple sap collection has greatly reduced the amount of labor required for sap collection and increased the overall efficiency of collection operations. Plastic tubing systems consist of lateral lines connected to tapholes of maple trees that are connected to a main line which flows directly to a collection tank. However, issues remain with current plastic tubing systems. For example, plastic tubing can sag or deform due to changes in weather, lack of proper maintenance, and/or aging of materials. Sagging of plastic tubing can contaminate fresh sap by causing a buildup of sap that may heat up and ferment and/or cause bacterial growth, producing sour and off-flavor sap. Additionally, sagging tubes can increase vacuum loss, which can render the system unusable.

As can be seen, there is a need for a manual tube lashing apparatus that constricts maple tubing to prevent sagging.

### SUMMARY OF THE INVENTION

In one aspect of the present invention, a tube lashing apparatus is provided. The tube lashing apparatus can include a body configured to receive tubing. The body of the tubing apparatus can include a first portion, including a first plurality of bearings disposed along an inner aspect of the first portion, a first handle proximate to a first end of the first portion, and a first guide wire assembly proximate to a second end of the first portion; and a second portion, including a second plurality of bearings disposed along an inner aspect of the second portion, a second handle proximate to a first end of the second portion, and a second guide wire assembly proximate to a second end of the second portion. The first portion can be connected to the second portion using at least one hinge, and the first portion can be secured to the second portion using at least one latching mechanism. Each of the first portion and the second portion can have a wiring assembly connected thereto via a bolt. Each wiring assembly can include a spool configured to accept wiring installed on the bolt and a tensioning mechanism configured to maintain a force on the spool to prevent sagging, or freewheeling.

These and other features, aspects and advantages of the present invention will become better understood with reference to the following drawings, description, and claims.

### BRIEF DESCRIPTION OF THE DRAWINGS

FIG. 1 is a front elevation view of a tube lashing apparatus, according to an embodiment of the present invention;

FIG. 2 is a perspective view thereof;

FIG. 3 is an exploded view thereof; and

FIG. 4 is a perspective view thereof, shown in an open position.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a manual tube lasher for lashing maple tubing, thereby constricting the tubing and preventing sags.

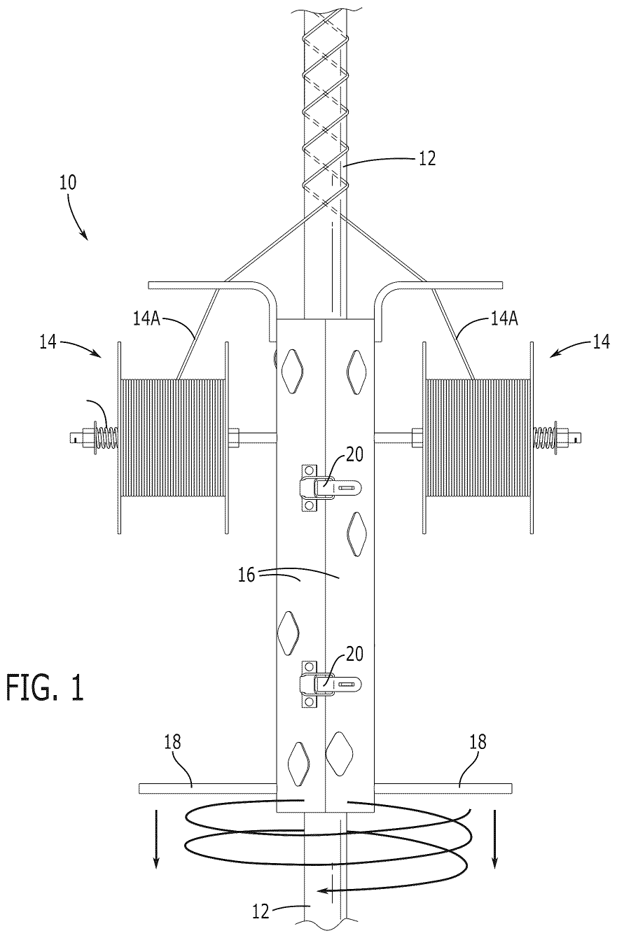

Referring to FIGS. 1-5, an exemplary embodiment of a tube lashing apparatus 10 is illustrated. Tube lashing apparatus 10 can have a main body formed from two pipe halves 16. Pipe halves 16 can be semi-cylindrical and formed from metallic material but are not so limited. In differing embodiments, Pipe halves 16 can be varied in both inner diameter and outer diameter to accommodate differing tubing sizes. The main body of tube lashing apparatus 10 can include a plurality of latching mechanisms 20 configured to secure pipe halves 16 in a closed configuration. When positioned as shown in FIG. 1, the pipe halves 16 form a sleeve-like assembly with an inner tubular opening which can accommodate tubing 12, such as maple tubing. Each pipe half 16 can have mounted, proximate to a first end, a handle 18. Handle(s) 18 may be attached, or positioned, such that when tube lashing apparatus 10 is positioned as shown in FIG. 1, they are oriented 180° from one another.

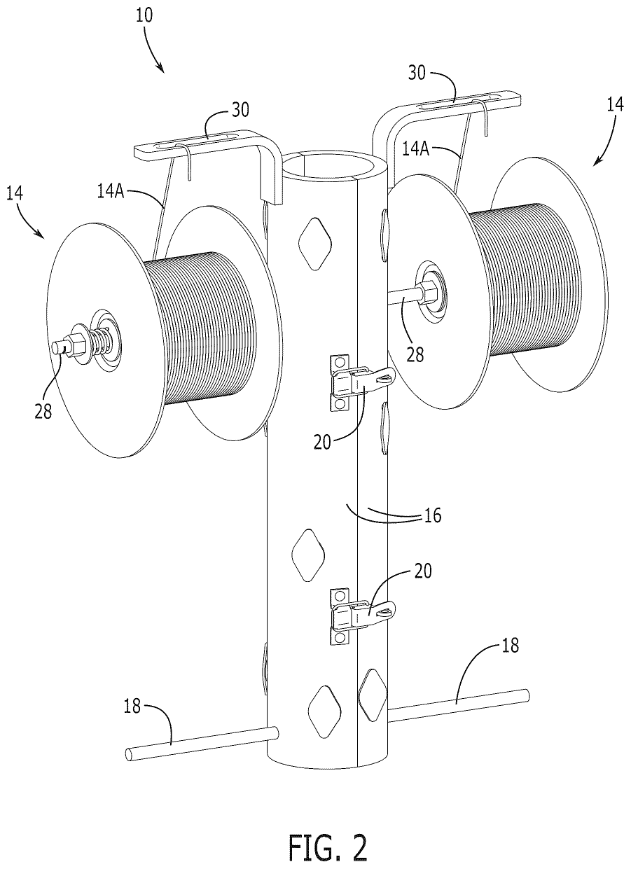

Turning to FIG. 2, each pipe half 16 can have mounted, proximate to a second end, a guide wire assembly 30. Guide wire assembly 30 can be substantially L-shaped with an elongated cutout portion configured to accept wiring 14A. Advantageously, guide wire assembly 30 can be configured to maintain even wrapping of wire 14A around tubing 12 during installation. Pipe Halve(s) 16 of tube lashing apparatus 10 can each have a wiring assembly mounted thereon.

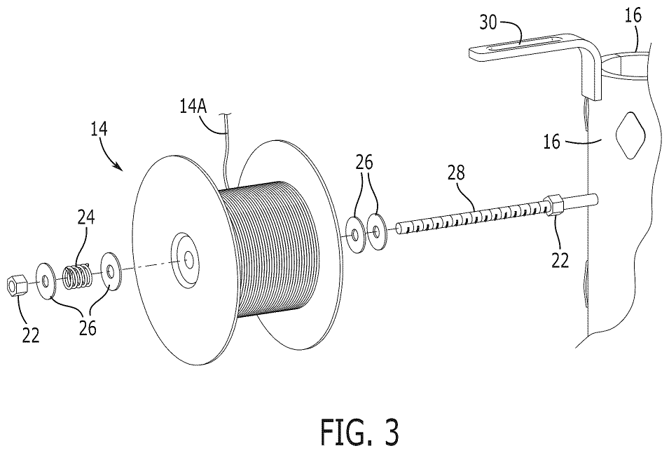

Each wiring assembly can include a spool 14 for housing wiring 14A and hardware 22, 24, 26, 28 (see FIG. 3) operative to mount the wiring assembly to the pipe halve(s) 16. In embodiments, a wiring assembly can include a carriage bolt 28 protruded from a pipe half 16 and affixed thereto, with an inner nut 22 disposed on the threading of carriage bolt 28 that is proximate to the pipe half 16. At least 2 washers 26 can be disposed between inner nut 22 and spool 14 to provide secure attachment. A tensioning assembly 24, 26 can be provided for the wiring assembly to prevent wire 14A from becoming loose, or sagging, when apparatus 10 is not in use. In embodiments, the tensioning assembly can be a spring 24 disposed between two washers 26 and secured to the threading of the carriage bolt 28 distal to the pipe half 16 using an outer nut 22 and in contact with spool 14. Advantageously, outer nut 22 can be adjustably tightened to cause sufficient compression of spring 24, which can prevent freewheeling of spool 14.

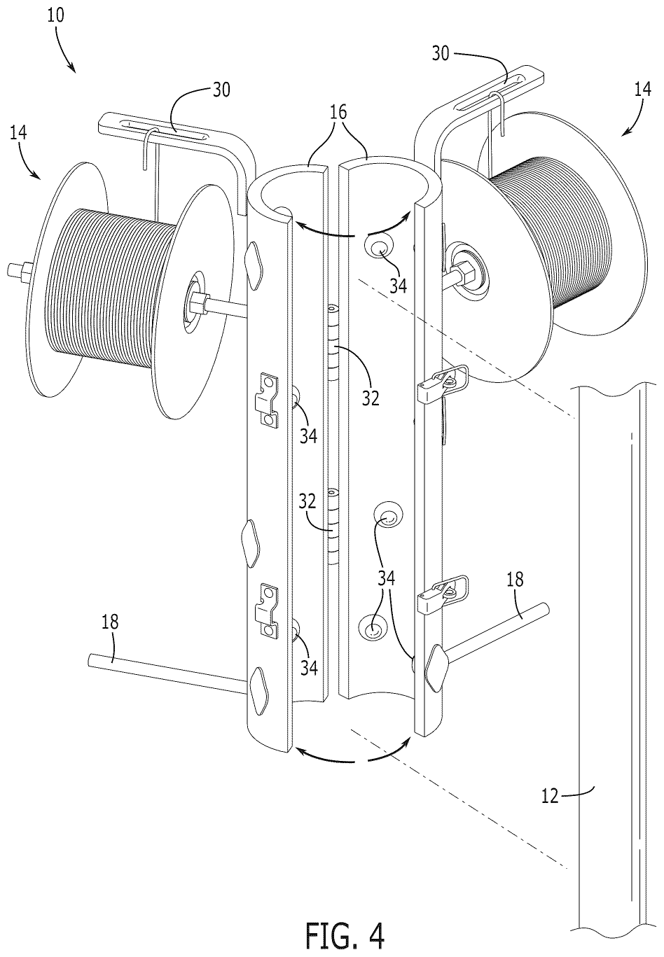

Turning to FIG. 4, the main body of tube lashing apparatus 10 can be formed to be clamshell like, with a plurality of hinges 32 connecting portions of each pipe half 16 to one another. Advantageously, the clamshell like configuration can allow the main body of tubing apparatus 10 to accept tubing 12 of varying sizes. Each pipe half 16 can have a plurality of holes, each hole having a ball bearing 34 disposed therein. In embodiments, ball bearing(s) 34 are disposed in a staggered manner or otherwise evenly spaced. Advantageously, ball bearing(s) 34 allow smooth movement of tube lashing apparatus 10 over tubing 12, disposed therein.

To use the tube lashing apparatus 10, the user can place it in an open position around tubing 12, as illustrated in FIG. 4. Tube lashing apparatus 10 can then be placed in a closed position, as shown in FIG. 1, with latching mechanisms 20 secured. When in a closed position, a user can grip handles 18 and move tube lashing apparatus 10 along tubing 12, aided by bearings 34, in a twisting manner illustrated in FIG. 1, which causes wire 14A to form a helical binding pattern around tubing 12. Advantageously, the helical binding pattern can constrict tubing 12 to form a more rigid structure, which is more resilient to sagging or other deformations.

It should be understood, of course, that the foregoing relates to exemplary embodiments of the invention and that modifications may be made without departing from the spirit and scope of the invention as set forth in the following claims.

What is claimed is:

1. A tube lashing apparatus comprising:
a body having an open position and a closed position, the body having an exterior surface and an interior surface having a diameter configured to receive tubing longitudinally in the closed position, the body including:
a first semi-cylindrical shell having a first end and a second end, with a first longitudinal margin and a second longitudinal margin extending therebetween; a first handle extending from the exterior surface proximate to the first end; and a first lashing assembly extending from the exterior surface proximate to the second end;
a second semi-cylindrical shell having a third end and a fourth end, with a third longitudinal margin and a fourth longitudinal margin extending therebetween; a second handle extending from the exterior surface proximate to the third end; and a second lashing assembly extending from the exterior surface proximate to the fourth end, wherein the third longitudinal margin is hingedly coupled to the first longitudinal margin; and
at least one latching mechanism configured to secure the fourth longitudinal margin to the second longitudinal margin.

2. The tube lashing apparatus of claim 1, wherein the first and second handles comprise rods extending orthogonally from an exterior surface of the respective shell.

3. The tube lashing apparatus of claim 1, wherein the first and second lashing assemblies each comprise a rod extending orthogonally from the exterior surface; a lashing wire spool rotatably mounted on the rod; and a wire guide adjacent to the lashing wire spool.

4. The tube lashing apparatus of claim 3, wherein the wire guide is substantially L-shaped with an elongated slot formed in leg thereof.

5. The tube lashing apparatus of claim 3, further comprising lashing wire wound about the lashing wire spool and extending through a slot formed in the wire guide.

6. The tube lashing apparatus of claim 3, the first and second lashing assemblies further comprising a tensioning mechanism mounted on the rod and configured to maintain a force on the lashing wire spool.

7. The tube lashing apparatus of claim 6, wherein the tensioning mechanism comprises a spring disposed between two washers and fastened to the rod with a nut.

8. The tube lashing apparatus of claim 1, further comprising a plurality of ball bearings, each disposed within spaced apart recesses formed on the interior surface.

9. The tube lashing apparatus of claim 1, wherein the body is formed of a metal.
